(19) United States
(12) Patent Application Publication
(10) Pub. No.: US 2023/0157261 A1
(43) Pub. Date: May 25, 2023

(54) METHOD FOR TRAINING ANIMALS TO INTERACT WITH ELECTRONIC SCREEN DEVICES

(71) Applicant: Jennifer Marie Cunha, Jupiter, FL (US)

(72) Inventor: Jennifer Marie Cunha, Jupiter, FL (US)

(21) Appl. No.: 17/530,464

(22) Filed: Nov. 19, 2021

(51) Int. Cl. A01K 15/02

(52) U.S. Cl. CPC A01K 15/02

(57) ABSTRACT

The present invention relates to an advancement in a system and method of training animals. The process allows humans to use existing commercially-available tablet-based apps that were designed for inarticulate human children and specially train animals to use them in order to communicate about foods, beverages, activities, location preferences, feelings, and choice communication. The present system enables animals to utilize smart devices and enables them to choose the desired options from Yes/No and select the required item from the menus and sub menus. The system also allows humans to teach their animals emotion labels and time sequence communication skills so the animals can better communicate with their caregivers.

### COPYRIGHT NOTICE

A portion of the disclosure of this parent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates generally to the area of behavior modification of animals. More specifically, this invention pertains to a method and technique for training animals using smart devices and to communicate by touching pictures or symbols on an electronic screen, such as a tablet or television.

### Description of the Related Art

Nearly every owner of the 120 million dogs, cats, and birds in the United States would like for their pet to be better trained but often can not afford to have it done, don't know how to do it themselves or won't spend the time. Moreover, most pets, at least some of the time, have difficulty understanding what their trainers expect of them. As a result the training process can be long and filled with error.

Shocking devices of various kinds are well known in animal training. For instance, cattle prods find use in navigating cattle traffic. Other shock devices are used to wean calves and train horses. U.S. Pat. No. 4,539,937 by Workman describes a horse training collar which delivers a controlled shock to the horse as it's neck muscles expand during cribbing. U.S. Pat. No. 4,947,497 by Farkas describes a dog barking collar that produces a low shock at the onset of barking which increases in intensity if the dog continues to bark in order to distinguish between “watchdog barking” and “nuisance barking.” The obvious drawback to electrical shock treatment is that it is often considered repugnant and cruel.

Negative audio stimuli have been used as a more humane alternative for animal training. Many dog collars have been designed to emit an unpleasant sound in response to a dog's undesirable behavior. For instance, the “PeaceMaker” (trademark) dog collar by Humane Technology, Inc., College Station, Tex. produces a single high-intensity sound burst with a decrescendo pattern shortly after detecting the dog's bark while ignoring extraneous sounds of brief duration. U.S. Pat. No. 4,180,013 to Smith describes a collar which responds to barking by emitting a high frequency noise and mechanically vibrating the vocal cords of the dog. U.S. Pat. No. 5,061,918 to Hunter discloses a sound emitting collar which adjusts the sound intensity according to the previous behavior of the animal and also varies the sound pattern to avoid habituating the animal to the sounds.

Remote communication with animals is also known in the art. For example, U.S. Pat. No. 3,336,530 to Sloan et al. discloses a directional finding system for hunting dogs with a transmitter attached to a collar and a remote receiver which enables the trainer to locate the dog. U.S. Pat. No. 3,589,337 to Doss discloses a collar which administers a shock to a dog in response to a remotely transmitted signal. U.S. Pat. No. 4,202,293 to Gonda et al. discloses a dog collar with a sound emitting buzzer and shock terminals as well as a remote control which can activate the buzzer either alone or immediately followed by a light shock. U.S. Pat. No. 4,745,882 to Yarnall, Sr. et al. describes a device that administers a mild shock or unpleasant noise to a dog as it approaches the walls of a confined area. U.S. Pat. No. 4,766,847 to Venczel et al. also administers a shock to a dog as it approaches a predefined boundary but gradually increases the shock as the dog nears the boundary and continues the shock after the dog crosses the boundary. U.S. Pat. No. 4,967,696 to Tobias discloses a dog collar containing a receiver which emits a simple tone or a human voice upon being actuated by a remote transmitter. U.S. Pat. No. 5,054,428 to Farkus discloses a dog collar which can be actuated by a remote transmitter to apply a short duration shock to get the animal's attention and well as a more intense shock if the animal fails to conform to expected behavior.

The inherent disadvantage of the aforementioned prior art is that these devices provide only negative stimulation whereby the animal must either obey and respond properly or be punished. Positive feedback between the trainer and the animal is usually limited to voice and physical contact (petting) with neither being the primary means of training. It should be appreciated, however, that basic training theory centers on the animal learning signals for “YES” and “NO”. These are most often taught through a series of rewards and punishments. Moreover, trainers often fail to effectively train their pets because they are not consistent in the positive reinforcement (reward) and punishment that they impose on the animal. For efficient and speedy training of animals it is usually necessary to deliver not only a consistent and immediate negative stimulus (NO command) but also a consistent and immediate positive stimulus (YES command).

Positive reinforcement devices which avoid resorting to injury or abuse are known in the field of animal training. U.S. Pat. No. 4,535,724 by David discloses a horse training apparatus mounted on a horse's neck which includes a storage tank filled a sweet liquid, a tube extending from the tank to the horse's mouth, a pump, a battery and a switch so that a trainer or rider can press the switch to pump sweet liquid into the horse's mouth. In addition a second identical set of equipment containing sour liquid can be mounted on the opposite side of the horse's neck so that the horse can be rewarded (sweet liquid) or punished (sour liquid). In the field of dog barking, U.S. Pat. No. 4,335,682 to Gonda et al. describes a dog collar which produces a first sound at commencement of a shock and a second sound when the shock is finished. A remote transmitter allows the user to generate the shock accompanied by the first sound when the shock begins and second sound when the shock ends, as well as the first sound alone or the second sound alone. In theory, the animal becomes conditioned to regard the first sound as a warning signal and the second sound invokes feelings of safety, relief and relaxation in the animal so that the trainer later can apply reward (second sound) and punishment (first sound) without the shock. A drawback to Gonda et al. is that the use of shock is mandatory in order to condition the dog.

The use of auditory stimuli in animal learning and training dates from the classic works of Pavlov (1927) and Skimmer (1938). See, for instance, I. P. Pavlov, Conditioned reflexes, London: Oxford University Press, 1927; and B. F. Skinner, Behavior of Organisms, New York: Appleton-Century-Crofts, 1938. In the subsequent years, auditory stimuli have been used as rewards, inhibitors and discriminative stimuli in learning studies in a variety of species, including dogs and cats.

Another point to consider is the consistency of the level of the punishment. Most owners find it difficult to be consistent when disciplining their pet. Usually, too much of the owner's personal state of mind gets in the way. Furthermore, many of the previously discussed training devices by design administer inconsistent punishment. This inconsistency can confuse the animal and considerably lengthen training time.

Therefore, despite the availability of numerous positive reinforcement devices and punishment devices for behavior modification of animals, there is still a need for a humane training device that provides the consistent messages necessary to let the animal know when it is behaving correctly as well as incorrectly.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease-of-use ability of these assemblies is also questionable. The current invention proposes an advanced way to train communication to people and their animals. It not only stops the negative behavior but promotes positive behavior and communication among trainer/owner and pet. The current device includes a method for teaching animals to communicate with humans by using communication board programs.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior animal training devices and provide an enhanced system to perform the designated functionality.

Another object of the present invention is to provide a technological way of training animals by using a tablet, cell phone, television with interactive screen, or other touch-screen device, with a method for teaching animals to communicate with humans by using communication board apps and programs.

It is a further objective of the present invention to provide an improved methodology to allow humans to use existing tablet-based apps that are designed for inarticulate human children and specially train animals to use them in order to communicate about foods, beverages, activities, location preferences, feelings, and choice communication.

It is also an object of the invention to provide an easy-to-use process that teaches owners to train their animals on yes-no communication symbols and phonics skills for enhanced communication skills.

It is further the objective of the invention to provide a training system teaching humans to train their animals to use a simple touchscreen device with menus and sub-menus so that all animals (including animals who are unable to push with high degrees of pressure or who have mobility-limitations) are able to communicate using a communication board on a tablet.

It is also the objective of the invention to provide an assembly which increases control and ease of use and also enhances both the speed and quality of the entire procedure.

It is also the objective of the invention to provide a whole methodology which is easy to use and adopt for people with minimal additional cost.

Thus, it is the objective to provide a new and improved form of an advancement in animals training methodologies. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Further, although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Other features, aspects, and advantages of the subject matter described herein will become apparent from the following Detailed Description, Figures, and Claims.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a sample image of a parrot touching a dot on the screen using a commercially-available tablet app.

FIG. 2 illustrates a sample image of a parrot selecting a treat box on a commercially-available tablet-based communication app.

FIG. 3 illustrates a sample image of a parrot learning “Yes” and “No” symbols using red and green pipe cleaners.

FIG. 4. illustrates a sample image of a parrot using “Yes” and “No” on a commercially-available tablet-based communication app.

FIG. 5. illustrates a sample image of a tablet-based communication app main menu.

FIG. 6 illustrates a sample image of a tablet-based communication app emotion label menu.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

A communication gap often exists between humans and non-human animals. Due to lack of ability to understand one another, animals often develop behavior problems and experience frustration. Caregivers also feel frustrated because they don't know what their animal wants.

To date, there are no processes designed for teaching animals to communicate using a tablet, cell phone, or other electronic touchscreen device. There exists a mechanical button system designed to be used with dogs. Several limitations of any mechanical button system is the space needed, the inability of some animals to navigate the maze of buttons, the inability of some animals to press a button, and the lack of flexibility of presentation.

The proposed revolutionary training system teaches humans to train their animals to use a simple touchscreen device with menus and sub-menus so that all animals (including animals who are unable to push with pressure or who have mobility-limitations) are able to communicate using a communication board on a tablet. Additionally, the menus and submenus are housed in a single device and do not require much space in the house, nor costly buttons for purchase, which greatly expands the opportunities for increased vocabulary and communication.

In one aspect of the present invention, the current invention discloses a method of using a tablet, cell phone, or other touch-screen device, allowing to teach animals to communicate with humans by using communication board apps and programs.

The proposed method as per its preferred embodiments allows humans to also use existing commercially-available tablet-based apps that were designed for inarticulate human children and specially train animals to use them in order to communicate about foods, beverages, activities, location preferences, feelings, and choice communication.

The process as per its further embodiments also teaches owners to train their animals on yes-no, time-sequence, and emotion state communication symbols for enhanced communication skills.

The method as per its further embodiments utilizes apps and computer programs presented on a tablet, television, or other electronic screen that have built-in voice generated speech. The training steps include the following steps where the owner sets up the communication board with symbols to represent real-world outcomes. The owner trains the animal to first touch a treat-symbol box until the animal touches it fluently. After this the owner trains the animal to touch a second treat-symbol box until the animal touches it fluently.

The owner as per its further embodiments holds up a treat, and asks, “Which one [is this]?” to train the animal to discriminate between boxes. Once the animal demonstrates fluency on the first treat-box association discrimination, the owner holds up the second treat and asks, “Which one?” likewise to ensure the animal has learned to associate the second box with the correct food outcome. Finally, the owner asks, “Which one do you want?” and allows the animal to select between the boxes to receive the treat they request.

The system includes as per its further embodiments menus and submenus which are housed in a single device and do not require much space in the house which greatly expands the opportunities for increased vocabulary and communication.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I: A system and method to train animals using smart devices comprising:
A training system teaching humans to train their animals to use a simple screen-based device;
a training system with a main menu and the option of sub-menus so that all animals are able to communicate using a communication board on a tablet or other interactive screen-based device;
a training system providing the menus and submenus housed in a single device that does not require a large space and expands the opportunities for increased vocabulary and communication.

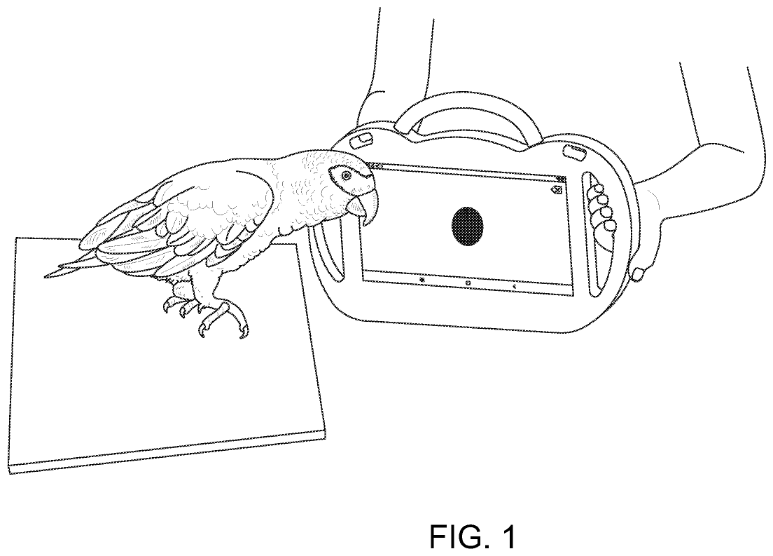

II: A system and method to train to touch the screen using a dual value treat reward system.
The owner sets up the screen-device with a music, coloring, or painting program that provides visual or auditory feedback when the animal engages in an interactive touch behavior [FIG. 1];
The owner encourages the animal to touch the center of the screen using a lower-value (or smaller amount) treat reward at a frequent rate of reinforcement or by placing the food treat on the screen;
When the animal touches the screen in a manner that elicits a response (auditory or visual); the owner additionally rewards the animal with a higher value (or greater quantity) treat reward until fluency is achieved with responsive touch interactions.

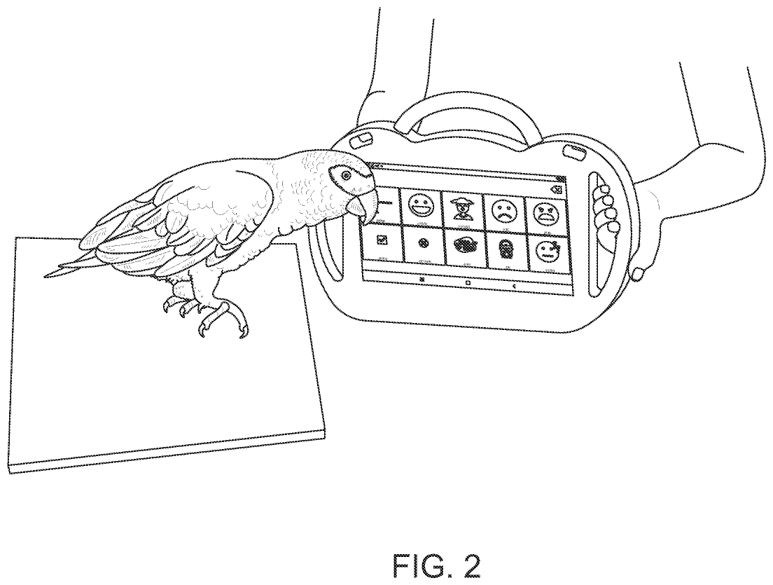

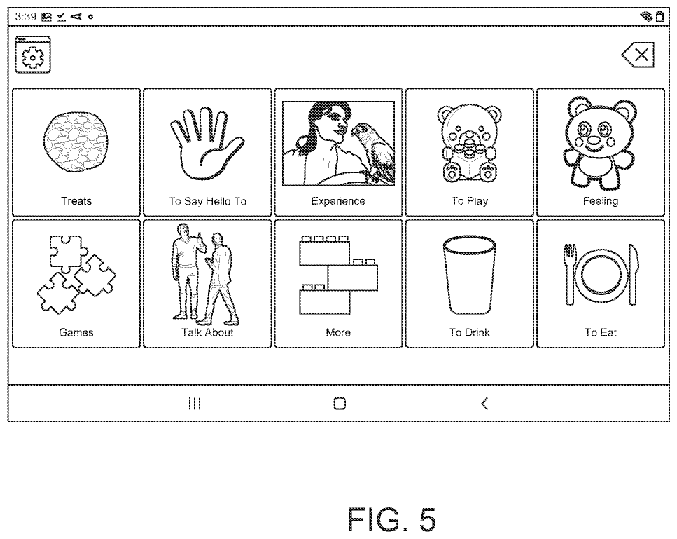

III: A system and method to train animals to request items on a touch screen device.
The owner sets up the communication board with two symbols, a higher-value one such as a treat, and a lower-value symbol, such as a secondary treat or a neutral object [FIG. 2];
The owner trains the animal to touch a first (higher-value) symbol box and associates it with the real-life outcome (such as a higher-value treat) until the animal touches it fluently;
The owner trains the animal to touch a second (lower-value) symbol box and associates it with a real-life outcome such as a lower-value treat) until the animal touches it fluently;
The owner asks, “Which one do you want?” and allows the animal to select between the boxes to receive the real-life outcome they request until consistency is achieved and the animal is fluently requesting their highest-value outcome (such as the higher-value treat) at 70% or greater accuracy;
(Optionally) the owner holds up a treat, and asks, “Which one?” to train the animal to discriminate between boxes. Once the animal demonstrates fluency on the first e.g., treat) box association discrimination, the owner holds up the second item (e.g., a second treat) and asks, “Which one?” likewise to ensure the animal has learned to associate the box with the second outcome; and
(Optionally) the owner sets up a main menu and submenus with meaningful vocabulary for the animal and continues vocabulary training [FIG. 5].

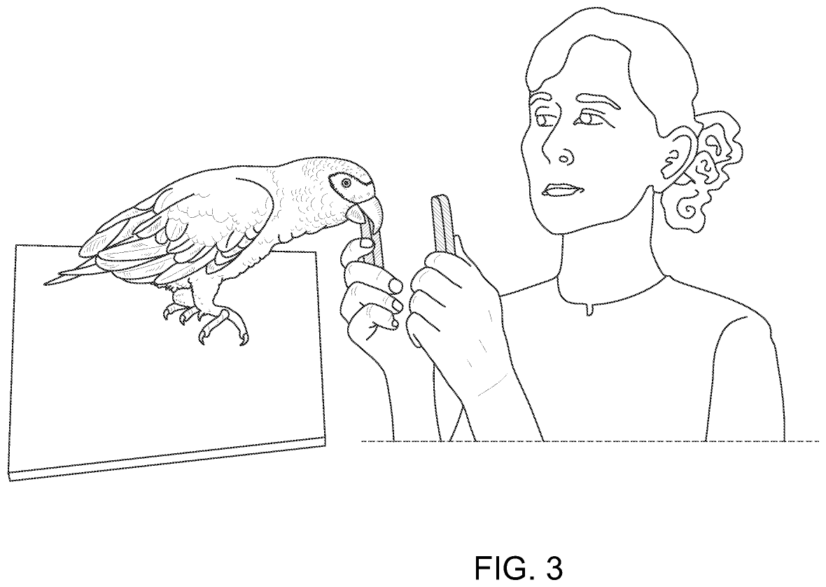

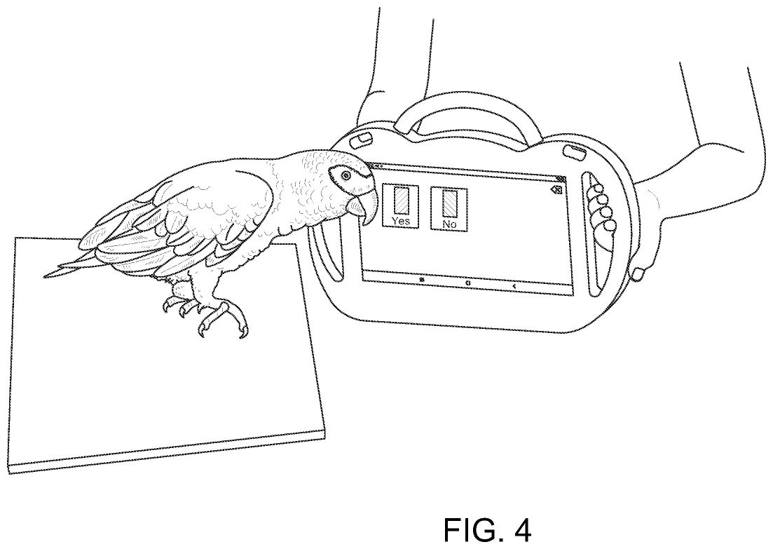

IV: A system and method to train animals allowing them to communicate Yes or No comprising following steps:
The owner sets up the communication board with yes and no symbols [FIG. 3];
The owner trains the animal to touch the “yes” symbol for a treat reward on cue until the animal touches it fluently;
The owner trains the animal to touch the “no” symbol for a treat reward on cue until the animal touches it fluently;
The owner asks, “Which one is yes?” and allows the animal to select between the boxes to select “yes” and receive a treat reward until consistency is achieved and the animal is fluently touching “yes” on cue with 70% or better accuracy;
The owner asks, “Which one is no?” and allows the animal to select between the boxes to select “no” and receive a treat reward until consistency is achieved and the animal is fluently touching “no” with 70% or better accuracy on cue;
The owner trains the animal to touch a high-value food reinforcer with a name label (e.g., “pine nut”) for a treat reward on cue until the animal touches it fluently;
The owner trains the animal to touch a lower-value item with a name label (e.g., “water” when the animal is satiated) for a treat reward on cue until the animal touches it fluently;
The owner asks, “Which one is [the food reinforcer]?” and allows the animal to select between the items to choose the food item and receive a treat reward until consistency is achieved and the animal is consistently selecting the food item between the two options on cue;
The owner asks, “Which one is [the lower-value item]?” and allows the animal to select between the items to select the lower-value object and receive a treat reward until consistency is achieved and the animal is consistently selecting the lower-value object between the two options on cue;
The owner then asks, “Do you want [trained food label]?” and allows the animal to select between the yes and no boxes on the communication board, training the animal to select the “yes” box for the trained food label. The owner repeats this method to associate the “no” box for the lower-value object;
The owner generalizes the training to other label-trained high value and lower-value items until fluency is demonstrated with yes and no question responses; and
The owner corroborates the yes and no questions by asking follow-up questions and with body language consistency to ensure high fidelity in communication, and then optionally adds the symbols to the screen-based communication board [FIG. 4].

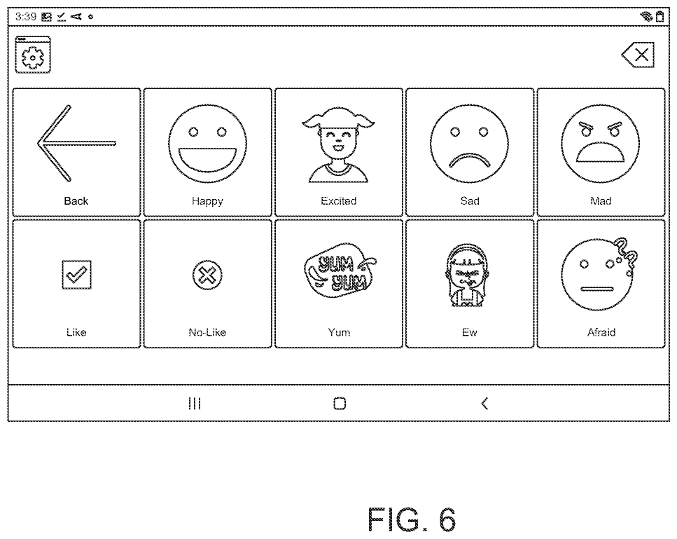

V: A system and method to train animals allowing them to communicate their feelings:
The owner sets up the communication board with feeling symbols (e.g., happy, sad, mad, afraid, excited, calm, sleepy) [FIG. 6];
For each feeling label, the owner observes 1) a behavioral repertoire (e.g. for “excited” in a parrot, wings spread, bobbing torso, specific vocalization, relaxed facial feathers), and 2) three trigger labels (e.g., “Grandma,” “Dad,” and “outside”);
Using the animal's primary source of information input (visual, auditory, touch, taste, or olfactory), the owner trains the animal to develop symbol-based vocabulary;
Through associative conditioning, the owner teaches the animal the word labels for one feeling label's triggers (e.g., “excited” behavior repertoire and label—Grandma as associated with a particular human, Dad as associated with a different human, outside as associated with a location);
The owner similarly teaches the animal the word labels for another feeling label's triggers (e.g., “happy” behavior repertoire and label treat as associated with a high value food item, chew toy as associated with a particular toy, pet as associated with physical affection);
Once the owner has taught: the animal three word labels for each feeling state, the owner teaches the feeling as a category by stating (e.g.) “You feel excited about grandma!” and targeting the animal to touch the EXCITED label on the communication board for several repetitions until fluency is achieved. The owner repeats the associative conditioning with the other two trigger labels by stating “You feel excited about outside!” and “You feel excited about Dad!” until fluency is achieved with the animal pressing the excited label when cued “How do you feel about . . . ” trigger words;
The owner repeats this training with the next feeling state category (e.g., happy as associated with treat, chew toy, and ball);
The owner offers a discrimination task, asking “How do you feel about . . . ” (e.g., ball) and offering the communication board to the animal. If the animal selects happy, the owner rewards the animal, if the animal selects excited, the owner withdraws the communication board for a period of 1-3 seconds and then recces for up to two attempts;
If the animal answers incorrectly on multiple cues, the owner repeats the feeling label training until fluency is achieved;
Once the animal demonstrates fluency on “How do you feel about, . . . ?” questions on trained and feeling-associated vocabulary, the owner generalizes the training to other trained labels until fluency is demonstrated with feeling-label responses; and
The owner corroborates the animal's feeling state responses with body language/feeling behavior repertoire consistency to ensure high fidelity in communication.

VI: A system and method to train animals allowing them to communicate about yesterday-today-tomorrow time sequences:
The owner sets up the communication hoard with time symbol labels for yesterday, today, and tomorrow;
Using the animal's primary source of information input (visual, auditory, touch, taste, or olfactory), the owner trains the animal to develop symbol-based vocabulary;
Through associative conditioning, the owner trains the animal on vocabulary symbol labels for three activities that the animal enjoys (e.g., beach, walk, and etch);
On the first training day, the owner engages the animal in the first labeled activity, such as a beach visit;
On the second training day, the owner engages the animal in the second activity, such as a walk. The owner uses associative conditioning to associate the walk label with the symbol today. The owner also associates the beach label with the symbol yesterday. Finally, the owner associates the third activity label, fetch, with the symbol tomorrow. The owner also offers a discrimination task on the activity labels associated with the time labels by (e.g.) asking, “Which one is walk?” and training the animal to press the today, label and repeating the discrimination task with the other vocabulary to ensure the animal has achieved fluency in the associative conditioning;
On the third training day, the owner engages the animal in the third activity, such as a fetch. The owner uses associative conditioning to associate the fetch label with the symbol today. The owner also associates the walk label with the symbol yesterday. Finally, the owner associates the first activity label, beach, with the symbol tomorrow. The owner also offers a discrimination task on the activity labels associated with the time labels by (e.g.) asking, “Which one is walk?,” training the animal to press the yesterday, “Which one is fetch?,” training the animal to press the today label, and “Which one is beach?,” training the animal to press the tomorrow label to ensure the animal has achieved fluency in the associative conditioning;
On the fourth training day, the owner engages the animal in the first activity again, such as a beach visit. The owner uses associative conditioning to associate the beach label with the symbol today. The owner also associates the fetch label with the symbol yesterday. Finally, the owner associates the second activity label, walk, with the symbol tomorrow. The owner also offers a discrimination task on the activity labels associated with the time labels by (e.g.) asking, “Which one is fetch?,” training the animal to press the yesterday, “Which one is beach?,” training the animal to press the today label, and “Which one is walk?,” training the animal to press the tomorrow label to ensure the animal has achieved fluency in the associative conditioning; and
When the animal has achieved fluency in pressing the correct time labels for activities two days in a row, the training is concluded.
